(19) United States
(12) Patent Application Publication
(10) Pub. No.: US 2026/0318438 A1
(43) Pub. Date: Oct. 15, 2026

(54) SOLENOID VALVE AND DEVICE HAVING THE SOLENOID VALVE

(71) Applicant: SAFRAN AERO BOOSTERS, Herstal (BE)

(72) Inventors: Arnaud Luc Charles MAGETTE, Herstal (BE); Jean-Christian BOMAL, Herstal (BE); Cédric Louis Marie Ghislain FRIPPIAT, Herstal (BE)

(73) Assignee: SAFRAN AERO BOOSTERS, Herstal (BE)

(21) Appl. No.: 19/116,572

(22) PCT Filed: Sep. 26, 2023
(86) PCT No.: PCT/EP2023/076550

§ 371 Date: Mar. 28, 2025

(30) Foreign Application Priority Data
Sep. 28, 2022 (BE) 2022/5775

(51) Int. Cl. F16K 31/40; F02K 9/58

(52) U.S. Cl. CPC F16K 31/408

(57) ABSTRACT

A solenoid valve having a body with a main fluid inlet, a main fluid outlet and a main passage which connects the main inlet to the main outlet; a main flap with an obturator, the main flap being movable between a position of obturation of the main passage by the obturator and a position wherein the main passage is open, the main flap comprising an auxiliary fluid inlet in communication with the main inlet and an auxiliary fluid outlet in communication with the main outlet; an intermediate chamber connecting the auxiliary inlet and the auxiliary outlet and a pilot flap movable between a state of obturation of the auxiliary inlet and a state of obturation of the auxiliary outlet and for driving the main flap towards the open position.

### TECHNICAL FIELD

The present invention relates to a solenoid valve and to an equipment with the solenoid valve.

### PRIOR ART

The document EP2921753 discloses a valve for cryogenic gas. The valve comprises a body with a main inlet, a main outlet and a main passage connecting the main inlet to the main outlet. The valve also comprises a main obturator for the main passage, the main obturator comprising an auxiliary inlet, an auxiliary outlet in communication with the main outlet and an auxiliary passage which connects the auxiliary inlet to the auxiliary outlet. The valve further comprises an auxiliary obturator comprising a closing surface configured to cut the auxiliary passage and to drive the main obturator in the closing direction. The auxiliary obturator also comprises a drive surface configured to drive the main obturator in the opening direction by bearing on the edge of the auxiliary inlet and partially blocking it in order to slow down a flow. The disadvantage of this valve is that it may only be used with a gaseous fluid, which restricts its field of application.

The document GB2276222 describes a solenoid valve for hot water central heating radiators. The document U.S. Pat. No. 4,746,093 describes a solenoid valve with a gaseous fluid supply at the inlet point. The document FR1305081 describes a valve comprising a main piston which moves longitudinally in a box and one of whose ends rests on the valve seat at the end of one of its strokes, and an auxiliary piston arranged inside the main piston and configured to guide the latter. A clearance is provided between the main piston and the inner wall of the valve box accommodating the main piston. Advantageously, this document does not comprise a seal between the outer wall of the main piston and the inner wall of the valve box accommodating the main piston. This allows a clearance between the main piston and the inner wall of the valve box accommodating the main piston, so that the main piston may be positioned on the seat of the valve. The auxiliary piston, under the effect of its own weight, presses against the seat of the valve and closes it. Finally, according to this document, this valve is particularly suitable for high-viscosity substances and for cases where the temperature is high, due to the absence of a seal between the main piston and the inner wall of the valve box accommodating the main piston. The disadvantage of the valve of these documents is that its operation restricts its field of use.

There is a need for a valve with a wider range of applications.

### SUMMARY OF THE INVENTION

To this end, the invention proposes a solenoid valve comprising a body with a main fluid inlet, a main fluid outlet and a main passage connecting the main inlet to the main outlet; a main flap with an obturator, the main flap being movable between a position of obturation of the main passage by the obturator and a position of opening of the main passage, the main flap comprising an auxiliary fluid inlet in communication with the main inlet and an auxiliary fluid outlet in communication with the main outlet; an intermediate chamber connecting the auxiliary inlet and the auxiliary outlet; a pilot flap movable between a state of obturation of the auxiliary inlet and a state of obturation of the auxiliary outlet and for driving the main flap towards the open position.

In one variant, the pilot flap is further configured to drive the main flap towards the position of obturation of the main passage.

In one embodiment, the pilot flap is configured to drive the main flap towards the open position by biasing on a surface of the main flap or towards the obturate position by biasing on another surface of the main flap.

In one variant, the pilot flap is in a bore of the main flap, with the radial displacement of the pilot flap in the bore maintaining the sealing of the obturation of the auxiliary inlet or of the auxiliary outlet.

In one variant, the axial displacement of the pilot flap is less than the axial displacement of the main flap.

In one variant, the solenoid valve is able to receive the fluid which is propellant in a single-phase liquid state, in a single-phase gas state or in a two-phase liquid and gas state.

In one variant, the solenoid valve further comprises an enclosure, the main flap comprising a piston movable in the enclosure and separating the intermediate chamber from the main inlet within the enclosure.

In one variant, the auxiliary inlet is in the piston and the auxiliary outlet is in the actuating rod.

In one variant, the main flap is driven towards the open position of the main passage with the pilot flap in the state of obturation of the auxiliary inlet and by draining the intermediate chamber towards the main outlet.

In one variant, the solenoid valve further comprises an enclosure, the main flap comprising a piston movable in the enclosure and separating the intermediate chamber from the main outlet within the enclosure.

In one variant, the auxiliary inlet is in the actuating rod and the auxiliary outlet is in the piston.

In one variant, the main flap is driven towards the open position of the main passage with the pilot flap in the state of obturation of the auxiliary outlet and by filling the intermediate chamber from the main inlet.

In one variant, the main flap comprises an actuating rod connecting the piston to the obturator.

In one embodiment, the solenoid valve comprises an electromagnetic actuator with a solenoid and a ferromagnetic core actuated by the magnetic flux of the solenoid, the pilot flap being actuated by the core.

The invention also relates to an equipment with a solenoid valve as previously described, the equipment being an aerospace or aeronautical equipment, such as a space launcher or an aircraft turbomachine supplied with hydrogen or a space launcher.

The use of the verb “comprise” and its variants, as well as its conjugations in this document, may not in any way exclude the presence of elements other than those mentioned. The use in this document of the indefinite article “a”, “an”, or the definite article “the” to introduce an element does not exclude the presence of a plurality of these elements.

The terms “first”, “second”, “third”, etc. are used in this scope of this document exclusively to differentiate between different elements, without implying any order between these elements.

All the preferred embodiments and all the advantages of the solenoid valve according to the invention apply mutatis mutandis to the present equipment and vice versa. The various embodiments may be considered individually or in combination.

### BRIEF DESCRIPTION OF THE FIGURES

Further characteristics and advantages of the present invention will become apparent from the following detailed description, for the understanding of which reference is made to the attached figures which show:

FIG. 1 shows a schematic view of an example of embodiment of a valve according to the invention;

FIG. 2 shows a schematic view of another example of embodiment of a valve according to the invention;

FIGS. 3 and 4, schematic views of another example of embodiment of the valve according to the invention.

The drawings in the figures are not to scale. Similar elements are generally denoted by similar references in the figures. In the scope of this document, the same or similar elements may have the same references. Furthermore, the presence of reference numbers or letters in the drawings may not be considered as limiting, even when these numbers or letters are indicated in the claims.

### DETAILED DESCRIPTION OF EMBODIMENTS OF THE INVENTION

The invention relates to a solenoid valve comprising a body with a main fluid inlet, a main fluid outlet and a main passage which connects the main inlet to the main outlet. The solenoid valve also comprises a main flap with an obturator, the main flap being movable between a position of obturation of the main passage by the obturator and a position of opening of the main passage, the main flap comprising an auxiliary fluid inlet in communication with the main inlet and an auxiliary fluid outlet in communication with the main outlet. The solenoid valve also comprises an intermediate chamber connecting the auxiliary inlet and the auxiliary outlet, and a pilot flap movable between a state wherein the auxiliary inlet is in an obturation state and a state of obturation of the auxiliary outlet, and for driving the main flap towards the open position. Thanks to the pilot flap, the solenoid valve provides a better management of the auxiliary inlet and of the auxiliary outlet and therefore a better control of the intermediate chamber. This allows to extend the range of use of the solenoid valve, with a fluid in a liquid, gaseous or two-phase state, in particular propellant in a liquid, gaseous or two-phase state (preferably cryogenic propellant).

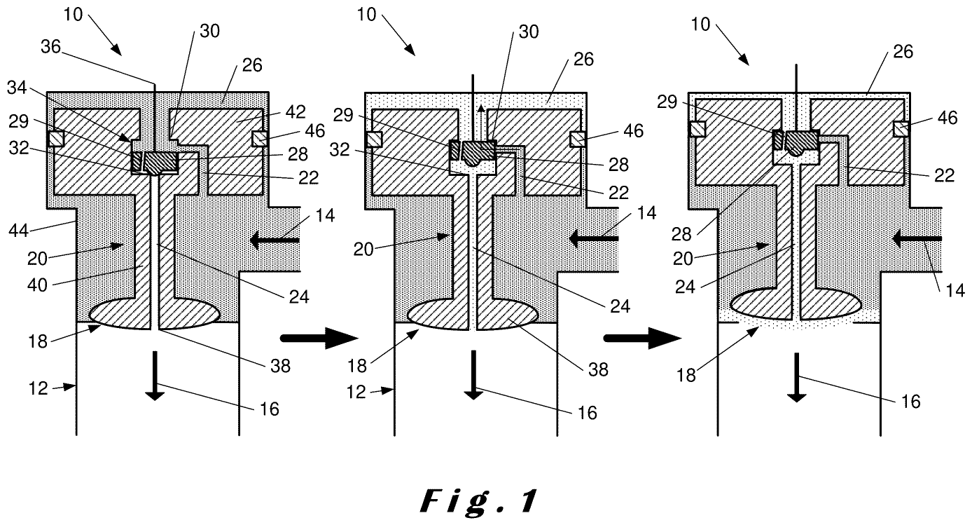

FIGS. 1 to 4 illustrate embodiments of the solenoid valve in accordance with the invention. In the figures, the solenoid valve 10 comprises a body 12 with a main fluid inlet 14 and a main fluid outlet 16. A main passage 18 connects the main inlet 14 to the main outlet 16. The main passage 18 puts the main inlet 14 and the main outlet 16 in fluid communication. The solenoid valve 10 also comprises a main flap 20 which may be moved between a position of obturation of the main passage 18 and a position of opening the main passage 18. By moving the main flap 20 towards the open position or towards the closed position, it is possible to control the distribution of a fluid towards distribution circuits within an item of equipment wherein the solenoid valve is installed.

In the figures, the high-pressure areas are shown darker than the intermediate-pressure areas, which are themselves darker than the low-pressure areas.

The main flap 20 comprises an auxiliary fluid inlet 22 in communication with the main inlet 14 and an auxiliary fluid outlet 24 in communication with the main outlet 16. The solenoid valve 10 comprises an intermediate chamber 26 which connects the auxiliary inlet 22 and the auxiliary outlet 24. The communication between the auxiliary inlet 22 and the main inlet 14 allows the intermediate chamber 26 to be filled from the main inlet 14, thereby increasing the pressure in the intermediate chamber 26. The communication between the auxiliary outlet 24 and the main outlet 16 allows the intermediate chamber 26 to drain towards the main outlet 16, thereby reducing the pressure in the intermediate chamber 26.

The solenoid valve also comprises a pilot flap 28 which may move between a state of obturation of the auxiliary inlet 22 and a state of obturation of the auxiliary outlet 24. This allows better management of the opening or closing of each auxiliary inlet and auxiliary outlet. The pilot flap provides a better pressure control in the intermediate chamber. This allows to extend the range of use of the solenoid valve, with a fluid in a liquid, gaseous or two-phase state, in particular propellant, especially cryogenic propellant. The pilot flap 28 may also move the main flap 20 towards the open position. In this way, the main passage may be opened by the combined action of the pilot flap and the pressure management in the intermediate chamber. In addition, the pilot flap 28 may be configured to drive the main flap 20 towards the position of obturation of the main passage 18. More generally, the solenoid valve is activated in one direction or the other by the combined action of the pilot flap and the pressure management in the intermediate chamber.

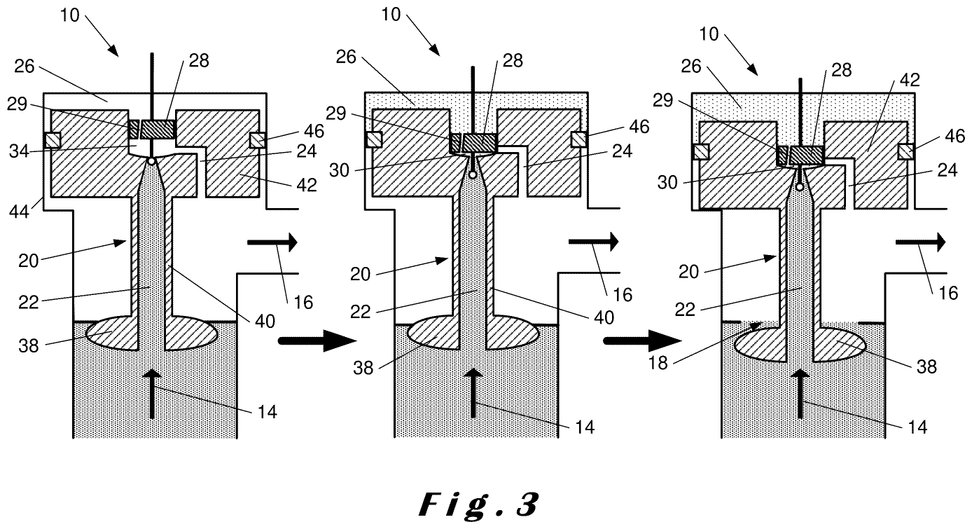

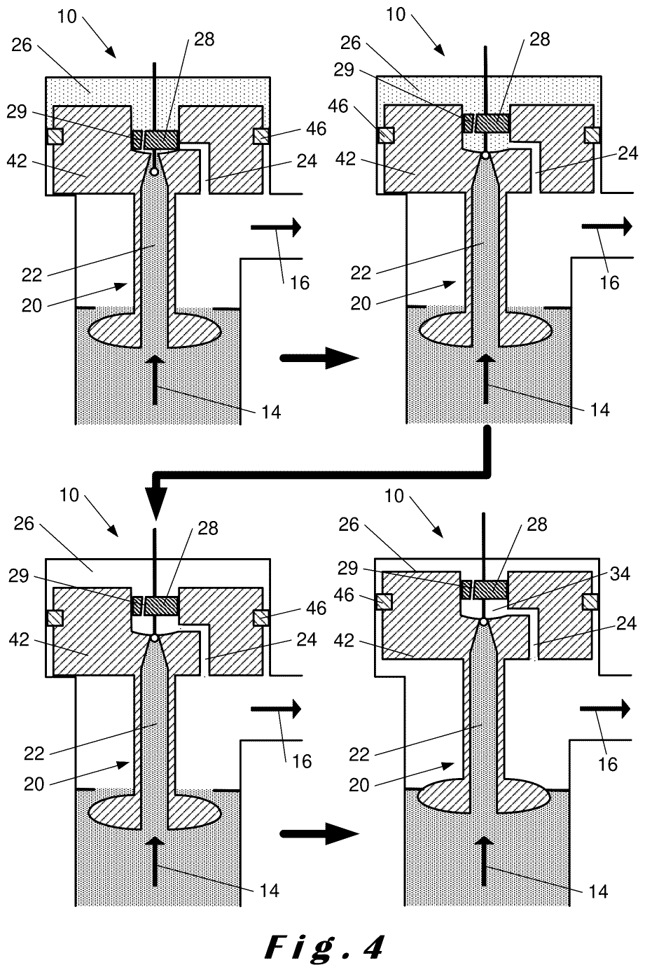

According to FIGS. 1 to 4, the pilot flap 28 is configured to drive the main flap 20 towards the open position by biasing on a surface 30 of the main flap and to drive the main flap 20 towards the obturate position by biasing on another surface 32 of the main flap 20. The main flap 20 is then driven by biasing the pilot flap 28 and by pressure management in the intermediate chamber 26. In FIGS. 3 and 4, only the surface 30 of the main flap 20 allowing the main flap 20 to be driven towards the open position is shown; the surface 32 may also be shown.

The pilot flap 28 may be in a bore 34 in the main flap 20. The shape of the pilot flap 28 maintains the sealing of the obturation of the auxiliary inlet or of the auxiliary outlet. The shape of the pilot flap 28 in relation to the bore 34 maintains the seal. The radial displacement of the pilot flap 28 in the bore 34 maintains the sealing of the obturation of the auxiliary inlet or of the auxiliary outlet. The clearance of the radial displacement is sufficient to allow the relative movement of the pilot flap in all circumstances, but small enough to significantly reduce the leakage cross-section when the pilot flap is opposite the auxiliary inlet 22 (filling duct-leakage according to the arrow through the pilot flap 28 in the middle position of FIG. 1, which is significantly reduced) or the auxiliary outlet 24 (draining duct, FIGS. 3 and 4). This provides a radial seal at the level of the auxiliary inlet 22 (filling duct) or of the auxiliary outlet 24 (draining duct) which is independent of the relative movements of the parts. In particular, this eliminates vibrations in the solenoid valve, while ensuring management of the auxiliary inlet and auxiliary outlet and therefore control of the intermediate chamber. This further improves the flow management in the auxiliary inlet 22 (filling channel or duct) and in the auxiliary outlet 24 (draining channel or duct). The advantage of the sealing obtained by the relative shape of the pilot flap 28 and of the bore 34 and in particular the radial displacement of the pilot flap 28 in the bore 34 is that this reduces the friction of the pilot flap in the bore 34 and therefore allows to reduce the need for force when the pilot piston 28 is actuated (by an actuator, for example).

As shown in FIGS. 1 and 3-4, the pilot flap 28 comprises a duct 29 allowing the intermediate chamber 26 to communicate with the downstream (or main outlet 16) via the auxiliary outlet 24.

In one embodiment, the main flap 20 comprises an obturator 38 for the main passage 18. The obturator 38 is shaped to match the periphery of the main passage 18 so as to provide a seal between the main inlet 14 and the main outlet 16, in the obturate position. The main flap 20 may also comprise an actuating rod 40 connecting a piston 42 to the obturator 38. The piston 42 is movable in an enclosure 44 of the body 12 of the solenoid valve. The piston 42 delimits the intermediate chamber 26 with one end of the enclosure 44. The piston may also delimit the main inlet 14 or the main outlet 16 with the main passage 18—as described below. The actuating rod 40 may be hollow to connect the intermediate chamber 26 to the main inlet 14 or the main outlet 16—as described later.

A sealing element 46 on the main flap 20, or more precisely on the piston 42, seals the intermediate chamber 26. The sealing element 46 allows to prevent leakage from the intermediate cavity 26, particularly at high pressure. The sealing element 46 ensures that the solenoid valve operates correctly.

The sealing within the solenoid valve 10 may be achieved between the main flap 20 and the enclosure 44 by the sealing element 46 and may be achieved between the pilot flap 28 and the main flap 20 by the shape of the pilot flap 28, in particular by a displacement (or adjustment) of the pilot flap 28 with respect to the main flap 20, preferably a radial displacement (or adjustment). This ensures sealing within the enclosure 44 while limiting the forces required to actuate the pilot flap 28, in particular by an actuator of the pilot flap 28 (and therefore a reduction in the mass of the actuator of the pilot flap 28).

Not shown, the solenoid valve 10 also comprises an electromagnetic actuator. The actuator comprises a solenoid and a ferromagnetic core driven by the magnetic flux of the solenoid. The pilot flap 28 is actuated by the core by means of a rod 36 in the figures. The advantage of this type of actuator is that it is lightweight and easy to control, since all you have to do to activate it is apply a voltage. In addition, such an actuator has the advantage of being quick to operate, which means that activation of the pilot flap 28 is also quick to operate. The fact of having a seal within the solenoid valve 10 obtained by the radial displacement of the pilot flap 28 in the bore 34 allows a relative movement between the main and auxiliary pistons while not altering the behavior of the solenoid valve. This has the advantage of allowing the actuator to run into a stop, thereby maximizing the electromagnetic force developed by the actuator. In this way, the electrical current required and therefore the mass and volume of the actuator are reduced-which is advantageous in the aeronautics and aerospace industries where the mass limitation is a major constraint, since the entire on-board mass must be propelled.

The fluid used in the solenoid valve is propellant in a single-phase liquid state, a single-phase gas state or a two-phase liquid and gas state. In particular, this involves cryogenic propellant, which changes phase under extreme temperature conditions. The solenoid valve is therefore a propellant-assisted valve with a solenoid actuator which uses the force available in the fluid pressure to actuate itself by managing the pressure in the intermediate chamber 26. The solenoid valve 10 is not dependent on its integration in the equipment, as it integrates its own intermediate chamber (balancing chamber). The performance of the solenoid valve depends on the operating conditions (pressure, temperature of the fluid and the environment, etc.), but over a very wide range of values. Unlike valves of the prior art, such as those for oil or any viscous substance, the solenoid valve 10 is used with propellants (e.g. oxygen, hydrogen, methane)—in particular cryogenic propellants—which may be in liquid, vapor (gaseous) or a combination of the two over a temperature range of 77K to 320K or more and a pressure range of 0 to 230 bar or more. These operating ranges are very wide compared with valves of the prior art. These ranges of values also allow the solenoid valve to be suitable for operation in aerospace or aeronautical type equipment, such as a space launcher or an aircraft turbomachine. The operating pressure and temperature ranges of the solenoid valve 10 cover different states of matter (liquid and/or gas). The management of the opening and obturation of the auxiliary inlet 22 and outlet 24 by the pilot flap 28 and the pressure in the intermediate chamber 26 allow the solenoid valve 10 to operate even though the operating pressure and temperature ranges involve significant changes in certain properties (density, compressibility, etc.). The use of propellant, particularly cryogenic propellant (e.g. oxygen, hydrogen or methane) has a state that may change depending on the temperature and pressure of the fluid. The solenoid valve 10 may therefore contain liquid, gas or a mixture of both phases at the same time. The operation of the solenoid valve is based on managing the pressure in the intermediate cavity 26 and this pressure is by definition variable. The solenoid valve 10 may start the draining process with a liquid fluid, which then becomes a gas as the pressure drops. The solenoid valve 10 may also have liquid at the inlet and gas in the intermediate cavity 26 or downstream. In addition, the sealing solutions for solenoid valve 10 provide a good compromise between leakage control (under the above conditions of use) and efficient operation, particularly in terms of the effort required to activate the pilot flap 28. This is not possible with valves of the prior art, such as valves for oil or any viscous substance, which are always used with a fluid (oil, for example) in a single-phase (liquid) with relatively constant (in)compressibility and relatively constant density. This is also not possible with the valves of the prior art, wherein the operating clearances allow leakage.

FIG. 1 shows an example of embodiment with the intermediate chamber 26 located upstream of the solenoid valve. In this embodiment, the intermediate chamber 26 is filled when the solenoid valve is closed and partially emptied to allow opening. The piston 42 of the main flap 20 separates the intermediate chamber 26 from the main inlet 14 within the enclosure 44. The auxiliary inlet 22 is in the piston 42 and the auxiliary outlet 24 is in the actuating rod 40. In FIG. 1, the solenoid valve 10 has an axial evacuation and a radial supply. Three positions are illustrated in FIG. 1 to show the opening of the solenoid valve 10.

In the left-hand position of FIG. 1, the solenoid valve 10 is closed, with the obturator 38 providing a seal between the main inlet 14 and the main outlet 16. The pilot flap 28 is in a state of obturation of the auxiliary outlet 24, biasing on the surface 32. The auxiliary inlet 22 is open and places the intermediate chamber 26 in fluid communication with the main inlet 14. The pressure in the intermediate chamber 16 is the same as upstream of the valve (main inlet 14) and maintains the valve in the closed position (the obturator 38 on the seat of the main passage 18). The pilot flap 28 helps to maintain the valve in the closed position by biasing on the surface 32.

In the middle position of FIG. 1, the solenoid valve 10 is always closed, with the obturator 38 providing a seal between the main inlet 14 and the main outlet 16. The pilot flap 28 is in a state of obturation of the auxiliary inlet 22, biasing on the surface 30. The auxiliary outlet 24 is open and places the intermediate chamber 26 in fluid communication with the main outlet 16. The intermediate chamber is being emptied downstream (towards the main outlet 16) via the actuating rod 40. The pressure in the intermediate chamber 26 decreases until pressure equilibrium is established on the main flap 20.

In the right-hand position in FIG. 1, this equilibrium is exceeded. The upstream pressure (main inlet 14) combined with the action of the pilot flap 28 on the surface 30 moves the solenoid valve 10 to the open position. The main flap 20 is driven towards the open position of the main passage 18 with the pilot flap 28 in the state of obturation of the auxiliary inlet 22 and by draining the intermediate chamber 26 towards the main outlet 16.

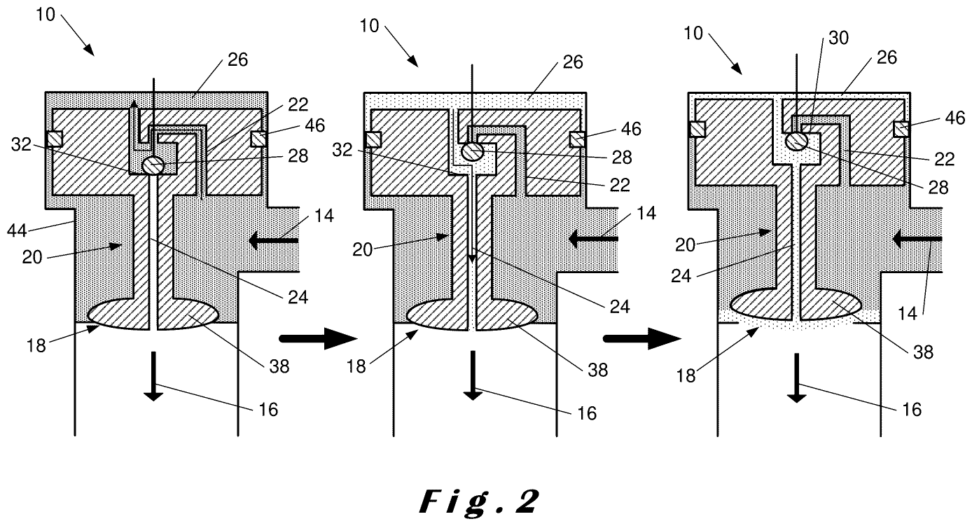

FIG. 2 shows another possible example of embodiment with the intermediate chamber 26 located upstream of the solenoid valve. In this embodiment, the intermediate chamber 26 is filled when the solenoid valve is closed and partially emptied to allow opening. The piston 42 of the main flap 20 separates the intermediate chamber 26 from the main inlet 14 within the enclosure 44. The auxiliary inlet 22 is in the piston 42 and the auxiliary outlet 24 is in the actuating rod 40. Three positions are illustrated in FIG. 2 to show the opening of solenoid valve 10.

In the left-hand position of FIG. 2, the solenoid valve 10 is closed, with the obturator 38 providing a seal between the main inlet 14 and the main outlet 16. The pilot flap 28 is in a state of obturation of the auxiliary outlet 24, biasing on the surface 32. The auxiliary inlet 22 is open and places the intermediate chamber 26 in fluid communication with the main inlet 14. The pressure in the intermediate chamber 26 is the same as upstream of the valve (main inlet 14) and keeps the valve in the closed position (the obturator 38 on the seat of the main passage 18). The pilot flap 28 helps to maintain the valve in the closed position by biasing on the surface 32.

In the middle position of FIG. 2, the solenoid valve 10 is always closed, with the obturator 38 providing a seal between the main inlet 14 and the main outlet 16. The pilot flap 28 is in a state of obturation of the auxiliary inlet 22, biasing on the surface 30. The auxiliary outlet 24 is open and places the intermediate chamber 26 in fluid communication with the main outlet 16. The intermediate chamber is being emptied downstream (towards the main outlet 16) via the actuating rod 40. The pressure in the intermediate chamber 26 decreases until pressure equilibrium is established on the main flap 20.

In the right-hand position in FIG. 2, this equilibrium is exceeded. The upstream pressure (main inlet 14) combined with the action of the pilot flap 28 on the surface 30 moves the solenoid valve 10 to the open position. The main flap 20 is driven towards the open position of the main passage 18 with the pilot flap 28 in the state of obturation of the auxiliary inlet 22 and by draining the intermediate chamber 26 towards the main outlet 16.

FIGS. 3 and 4 illustrate yet another possible example of embodiment with the intermediate chamber 26 located downstream of the solenoid valve 10. The operation is reversed compared with FIGS. 1 and 2. FIG. 3 shows the opening of the solenoid valve 10 and FIG. 4 shows the closing of the solenoid valve 10. In this arrangement, the chamber 26 is at downstream pressure (main outlet 16) when the solenoid valve 10 is closed and fills to allow opening. In other words, the intermediate chamber 26 empties when the solenoid valve is closed and fills completely or partially to allow opening. The piston 42 of the main flap 20 separates the intermediate chamber 26 from the main outlet 16 within the enclosure 44. The auxiliary outlet 24 is in the piston 42 and the auxiliary inlet 22 is in the actuating rod 40. Three positions are illustrated in FIG. 3 to show the opening of the solenoid valve 10.

In the left-hand position of FIG. 3, the solenoid valve 10 is closed, with the obturator 38 providing a seal between the main inlet 14 and the main outlet 16. The pilot flap 28 is in the state of obturation of the auxiliary inlet 22. The auxiliary outlet 24 is open and places the intermediate chamber 26 in fluid communication with the main outlet 16. The pressure in the intermediate chamber 16 is the same as downstream of the valve (main outlet 16) and the pressure upstream (main inlet 14) keeps the valve in the closed position (the obturator 38 on the seat of the main passage 18).

In the middle position of FIG. 3, the solenoid valve 10 is always closed, with the obturator 38 providing a seal between the main inlet 14 and the main outlet 16. The pilot flap 28 is in a state of obturation of the auxiliary outlet 24, biasing on the surface 30. The auxiliary inlet 22 is open and places the intermediate chamber 26 in fluid communication with the main inlet 14 via the duct 29. The intermediate chamber is being filled from upstream (main inlet 14) via the actuating rod 40. The pressure in the intermediate chamber 26 increases.

In the right-hand position of FIG. 3, the force exerted by the pressure on the upper surface of the piston 42 facing the intermediate chamber becomes greater than the force exerted by the pressure on the surface of the obturator 38 facing upstream. The pressure in the chamber 26 combined with the action of pilot flap 28 on the surface 30 moves the solenoid valve 10 to the open position. The obturator 38 is no longer on the seat of the main passage 18. The main flap 20 is driven towards the open position of the main passage 18 with the pilot flap 28 in the state of obturation of the auxiliary outlet 24 and by the pressure which continues to rise in the intermediate chamber 26.

Four positions are illustrated in FIG. 4 to show the closing of the solenoid valve 10.

The left-hand position in FIG. 4 corresponds to the position open to the right-hand position in FIG. 3.

In the second position shown in FIG. 4, the solenoid valve 10 is always open. The pilot flap 28 is in the state of obturation of the auxiliary inlet 22. The auxiliary outlet 24 is open and places the intermediate chamber 26 in fluid communication with the downstream (main outlet 16). The intermediate chamber 26 is emptying downstream (towards the main outlet 16) through the piston 42. The pressure in the intermediate chamber 26 decreases.

In the third position shown in FIG. 4, the intermediate chamber 26 is depressurized through the main flap 20. The pressure in the intermediate chamber 26 has decreased until pressure equilibrium is established on the main flap 20.

In the fourth position in FIG. 4, this equilibrium is exceeded. The upstream pressure (main inlet 14) is used to move the solenoid valve 10 to the closed position. The main flap 20 is driven towards the position where it obturates the main passage 18 with the pilot flap 28 in

### The State of Obturation of the Auxiliary Inlet 22 and by Draining the Intermediate Chamber 26

towards the main outlet 16.

In the example shown in FIGS. 3 and 4, only the opening surface 30 of the main flap 20 is shown; by biasing on the surface 30, the pilot flap 28 helps to open the main flap 20. In FIGS. 3 and 4, the surface 32 is not shown by way of example; it is possible to provide the surface 32 in the bore 34 so that, by biasing on the surface 32, the pilot flap 28 helps to actuate the main flap 20 to close. Generally speaking, in FIGS. 1-4, the pilot flap 28 has a “T” shape providing a mechanical stop with the main flap so that the latter may be actuated in the absence of pressure.

The pilot flap 28 and the main flap 20 move along a common axis, which is vertical in the figures. In the solenoid valve 10 of the embodiments, the displacement of the pilot flap 28 is less than the displacement of the main flap 20. More specifically, the axial displacement of the pilot flap 28 is less than the axial displacement of the main flap 20. The displacement of the pilot flap 28 is smaller than the displacement of the main flap 20. This allows the pilot flap 28 to actuate the main flap 20 without the solenoid valve 10 being in a hyperstatic situation. In this way, it is the actuator operating the pilot flap 28 which comes to a stop, even though the main flap 20 does not come to a stop in the body 12. The actuator actuating the pilot flap 28 comes to rest before the piston 42 comes into contact with the body 12 of the valve, which allows to optimize the actuator, particularly in terms of size and mass (which is advantageous in the aerospace industry). Thus, when the actuator is in the open position, the assembly of piston 4, actuating rod 40 and obturator 38 forming the main flap 20 still has the possibility of moving vertically (due to the variation in pressure in the cavity, for example) between a high position (upper surface of the piston 42 in contact with the body 12), and a low position (pilot 28 in contact with the surface 30 of the piston 42. The main flap 20 and the pilot flap 28 may be spherical or elliptical in shape to facilitate self-centering relative to the element where sealing is to take place, and the element may be provided with a conical facing seat. For example, the main passage 18 may have a conical seat. In FIGS. 1 and 2, the auxiliary outlet 24 may have a conical seat. The same applies to auxiliary inlet 22 in FIGS. 2 to 4. The pilot flap 28 may comprise a ball to ensure at least one of the two seals (with the auxiliary inlet 22 and/or the auxiliary outlet 24). This type of seal, consisting of a ball on a shaped seat, performs well. In FIG. 2, the pilot flap 28 is a ball and seals both the auxiliary inlet 22 and the auxiliary outlet 24. In FIG. 1, the pilot flap 28 comprises a ball to ensure a seal with the auxiliary outlet 24. In FIGS. 3 and 4, the pilot flap 28 comprises a ball to ensure a seal with the auxiliary inlet 22.

By taking advantage of the pressure available in the upstream fluid and managing the pressure in the intermediate chamber 26, the solenoid valve 10 may be autoclaved when closed while not having to overcome the upstream pressure to open it. In this way, the solenoid valve 10 has a good seal and the mass and cost are reduced for a given passage cross-section. In addition, the control of such a solenoid valve is simple compared with valves of the prior art and in particular motorized valves. In addition, not only does the solenoid valve 10 take advantage of the pressure available in the fluid upstream, but it may also be activated without pressure by the direct action of the pilot flap 28 actuated by the solenoid actuator.

The solenoid valve 10 is used to partition the auxiliary inlet 22 and the auxiliary outlet 24. The management of the auxiliary inlet 22 (filling channel or duct) and the auxiliary outlet 24 (draining channel or duct) allows the two flows to be managed independently and therefore allows operation despite the presence of possibly different phases within the fluid. The pilot flap 28, auxiliary inlet 22 and auxiliary outlet 24 assembly is a three-way system allowing both the filling and draining channels to be controlled. In FIGS. 1, 3 and 4, the pilot flap 28, auxiliary inlet 22 and auxiliary outlet 24 assembly is radially sealed to be independent of the relative movements of the parts.

In addition, the solenoid valve 10 may operate with a fluid that may change phase and with limited dependence on the circuit wherein the solenoid valve is integrated-unlike the valves in the prior art that use the pressure available in the flow and are limited to particular operating cases.

The invention also relates to an equipment comprising the solenoid valve 10. This may be a naval aircraft or aerospace equipment such as a space launcher or aircraft turbomachine. The equipment may run on propellant, preferably cryogenic propellant. The solenoid valve 10 may be an aeronautical or aerospace valve (launcher, rocket, rocket engine). It may be a cryogenic valve, particularly for aeronautical and aerospace purposes. The fact that the solenoid valve 10 is able to manage two-phase aspects means that it may be used in aeronautics, space launchers and cryogenics. The solenoid valve 10 may therefore also operate with propellant, particularly cryogenic propellant. It may therefore be cryogenic equipment. The solenoid valve 10 is particularly suitable for aeronautical and aerospace equipment. The solenoid valve 10 is suitable for use in aerospace applications because it operates independently of its own weight, and therefore independently of its orientation (and therefore of the orientation of the equipment), independently of the absence of gravity- and independently of vibration.

The present invention has been described above in connection with specific embodiments, which are illustrative and should not be considered limiting. In general, it will be apparent to a person skilled in the art that the present invention is not limited to the examples illustrated and/or described above.

1. A solenoid valve, comprising:
a body with a main fluid inlet, a main fluid outlet, and a main passage connecting the main inlet to the main outlet;
a main flap with an obturator, the main flap being movable between a position of obturation of the main passage by the obturator and a position of opening of the main passage, the main flap having an auxiliary fluid inlet in communication with the main inlet and an auxiliary fluid outlet in communication with the main outlet;
an intermediate chamber connecting the auxiliary inlet and the auxiliary outlet; and
a pilot flap movable between a state of obturation of the auxiliary inlet and a state of obturation of the auxiliary outlet and for driving the main flap towards the open position,
wherein the solenoid valve is configured to receive the fluid, and wherein the fluid is cryogenic propellant in a single-phase liquid state, a single-phase gas state, or a two-phase liquid and gas state.

2. The solenoid valve according to claim 1, wherein the pilot flap is further configured to drive the main flap towards the position of obturation of the main passage.

3. The solenoid valve according to claim 1, wherein the pilot flap is configured to drive the main flap:
towards the open position by biasing on a surface of the main flap; or
towards the obturate position by biasing on another surface of the main flap.

4. The solenoid valve according to claim 1, wherein the pilot flap is in a bore of the main flap, the radial displacement of the pilot flap in the bore maintaining the sealing of the obturation of the auxiliary inlet or of the auxiliary outlet.

5. The solenoid valve according to claim 1, the axial displacement of the pilot flap is less than the axial displacement of the main flap.

6. The solenoid valve according to claim 1, further comprising an enclosure, the main flap comprising a piston movable in the enclosure and separating the intermediate chamber from the main inlet within the enclosure.

7. The solenoid valve according to claim 6, wherein the auxiliary inlet is in the piston and the auxiliary outlet is in the actuating rod.

8. The solenoid valve according to claim 7, wherein the main flap is driven towards the open position of the main passage with the pilot flap in the state of obturation of the auxiliary inlet and by draining the intermediate chamber towards the main outlet.

9. The solenoid valve according to claim 1, further comprising an enclosure, the main flap comprising a piston movable in the enclosure and separating the intermediate chamber from the main outlet within the enclosure.

10. The solenoid valve according to claim 9, wherein the auxiliary inlet is in the actuating rod and the auxiliary outlet is in the piston.

11. The solenoid valve according to claim 10, wherein the main flap is driven towards the open position of the main passage with the pilot flap in the state of obturation of the auxiliary outlet and by filling the intermediate chamber from the main inlet.

12. The solenoid valve according to claim 6, wherein the main flap comprises an actuating rod connecting the piston to the obturator.

13. The solenoid valve according to claim 1, comprising an electromagnetic actuator with a solenoid and a ferromagnetic core actuated by the magnetic flux of the solenoid, the pilot flap being actuated by the core.

14. An equipment with a solenoid valve according to claim 1, the equipment being an aerospace or aeronautical equipment, such as a space launcher or an aircraft turbomachine.

15. The solenoid valve according to claim 9, wherein the main flap comprises an actuating rod connecting the piston to the obturator.
